(19) United States
(12) Patent Application Publication
(10) Pub. No.: US 2016/0347386 A1
(43) Pub. Date: Dec. 1, 2016

(54) ROBOT SYSTEM, LEG TYPE MOBILE ROBOT SYSTEM, CONTROL METHOD OF LEG TYPE MOBILE ROBOT SYSTEM, AND CONTROL METHOD OF ROBOT SYSTEM

(71) Applicant: MITSUBISHI HEAVY INDUSTRIES, LTD., Tokyo (JP)

(72) Inventors: Natsuki MATSUNAMI, Tokyo (JP); Tomohiro TAMI, Tokyo (JP); Yuki TANI, Tokyo (JP)

(21) Appl. No.: 15/117,331

(22) PCT Filed: Feb. 27, 2015
(86) PCT No.: PCT/JP2015/055961

§ 371 Date: Aug. 8, 2016

(30) Foreign Application Priority Data
Mar. 13, 2014 (JP) 2014-050816

(51) Int. Cl. B62D 57/032; G01B 11/24; G01C 7/04; G05D 1/02

(52) U.S. Cl. CPC B62D 57/032; G05D 1/024; G01B 11/24; G01C 7/04; G05D 2201/0217

(57) ABSTRACT

Landform data showing the shape of a ground surface (4) is acquired. A specification position is specified on the ground surface. A relative angle (432; 442) between the virtual plane (51) and the ground surface (4) in the at least one inspection point (433; 443) is calculated based on the landform data when the virtual plane (51) set with the reference point (423) and the at least one inspection point (433; 443) is virtually arranged such that the reference point (423) overlaps with the specification position, and such that the virtual plane (51) becomes parallel to the ground surface in the specification position. A landform determination value indicating a flatness of the landform is calculated based on the relative angle (432; 442).

### TECHNICAL FIELD

The present invention relates to a landform determining technique, and a control of a leg type mobile robot by using the landform determination.

### BACKGROUND ART

A leg type mobile robot such as a bipedal walking robot is known which moves using a plurality of legs. In the control of such a robot, it is important to recognize the state of a ground surface (a floor surface) on which a foot lands. When the ground surface is flat, the control is easy, but when there is an undulation in the ground, it becomes difficult to walk without losing a balance. Therefore, a technique in which a sensor such as a camera is attached to the head of a robot has been developed to detect the state of the ground surface for a walking control.

Patent Literatures 1 and 2 are examples of the technique of the walking control of the leg type mobile robot. Patent Literature 1 discloses a technique of generating gait data of the leg type mobile robot. Patent Literature 2 discloses a technique of generating a moving route plan of the leg type mobile robot.

### CITATION LIST

[Patent Literature 1] JP Patent 4,696,727
[Patent Literature 2] JP 2009-258779A

### SUMMARY OF THE INVENTION

For example, the leg type mobile robot is expected that it enters a place where the ground surfaces are complicated to work, such as a place where a robot moving with the wheel is difficult to enter. Also, it is expected that the leg type mobile robot works in the environment that the situation of the ground surfaces cannot be grasped. Therefore, a technique which makes it possible to control the leg type mobile robot appropriately according to the landform is requested.

In some embodiments, the landform determining apparatus includes a sensor configured to acquire landform data indicating a shape of a ground surface, a specification position generating section configured to specify a specification position on the ground surface, and a landform determining section configured to calculate a relative angle of a virtual plane and the ground surface in at least one inspection point based on the landform data, when the virtual plane set with a reference point and at least one inspection point is arranged such that the reference point is set to the specification position and such that the virtual plane becomes parallel to the ground surface, and calculate a landform determination value indicating a flatness of the landform based on the relative angle.

In some embodiments, the leg type mobile robot has a landform determining apparatus, and a controller configured to control such that a foot sole in the reference point becomes parallel to the ground surface when the foot sole is put on the specification position.

In some embodiments, a robot system has the leg type mobile robot and a remote control terminal. The remote control terminal includes a specification position generating section configured to generate the specification position based on an input operation to an input unit and an output unit configured to output the landform determination value. The remote control terminal transmits a command value to the leg type mobile robot when the input operation is carried out to set the specification position as the command value. The leg type mobile robot controls a leg according to the command value.

In some embodiments, a landform determining method includes acquiring landform data showing a shape of a ground surface, specifying a specification position on the ground surface, calculating a relative angle of a virtual plane and the ground surface in at least one inspection point based on the landform data, when the virtual plane set with a reference point and at least one inspection point is arranged such that the reference point overlaps with the specification position and such that the virtual plane becomes parallel to the ground surface, and calculating a landform determination value indicating a flatness of the landform based on the relative angle.

In some embodiments, a method of controlling a leg type mobile robot includes calculating a landform determination value by the landform determining method; and controlling such that a foot sole becomes parallel to the ground surface in the reference point when the foot sole is put on the specification position.

In some embodiments, a method of controlling a robot system is a method of controlling a robot system including a leg type mobile robot and a remote control terminal. The method of controlling a robot system includes controlling the leg type mobile robot. In the generating a specification position, the specification position is generated based on an input operation of an input unit of the remote control terminal. The method of controlling a robot system further includes outputting a landform determination value to the remote control terminal; transmitting a command value to the leg type mobile robot by the remote control terminal when the input operation is carried out to set the specification position as the command value; and controlling a leg according to the command value by the leg type mobile robot.

In some embodiments, the landform determining method is performed by a computer.

By some embodiments, a technique to make it possible to control a leg type mobile robot appropriately according to the landform is provided.

### BRIEF DESCRIPTION OF THE DRAWINGS

The attached drawings are incorporated into this Description to help the description of embodiments. Note that drawings should not be interpreted to limit the present invention to examples shown in the drawings.

FIG. 1 is a perspective view of a robot system.

FIG. 2 shows a walking apparatus and a ground surface.

FIG. 3 is a block diagram showing the configuration of a robot system.

FIG. 4 is a flow chart of an undulation avoidance control.

FIG. 5 shows a foot of a walking apparatus and the ground surface.

FIG. 6 shows a foot of a walking apparatus and the ground surface.

### DESCRIPTION OF THE EMBODIMENTS

In the following detailed description, many detailed specific items will be disclosed for the purpose of description, to provide the comprehensive understanding of embodiments. However, it would be apparent that one or plural embodiments can be practiced without these detailed specific items. Hereinafter, the embodiments will be described with reference to the attached drawings.

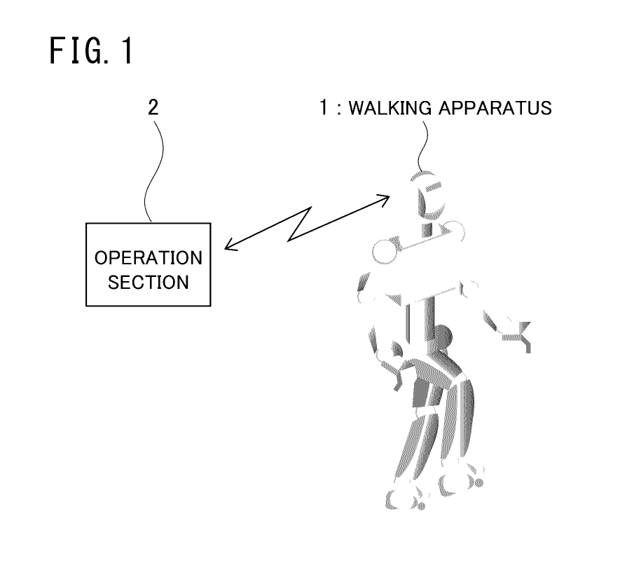

FIG. 1 is a perspective view showing a robot system of the present embodiment. The robot system contains a walking apparatus 1 and an operation section 2. For example, the walking apparatus 1 is a humanoid robot of bipedal locomotion. The walking apparatus 1 can carry out a radio communication with the operation section 2. An operator can control the walking apparatus 1 remotely by carrying out an input operation to the operation section 2 (an operation unit).

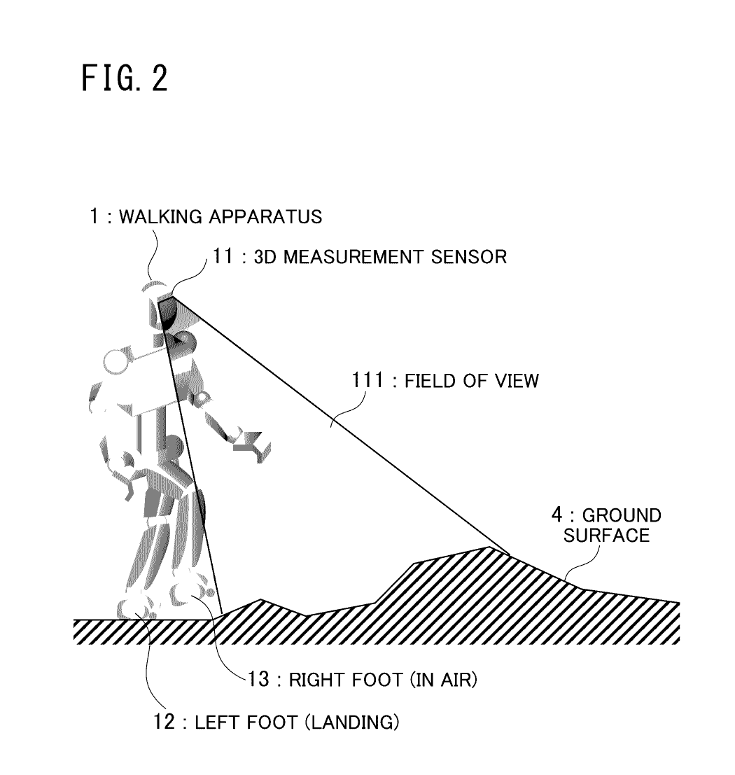

FIG. 2 shows the walking apparatus 1 and a ground surface 4. The walking apparatus 1 has a left foot 12 and a right foot 13. The walking apparatus 1 walks on the ground surface 4 by alternately stepping forward the left foot 12 and the right foot 13. For example, the walking apparatus 1 has a three dimensional (3D) measurement sensor 11 at the head. The 3D measurement sensor 11 can be realized by using a laser range finder, a stereo camera and so on.

The 3D measurement sensor 11 measures a distance from the 3D measurement sensor 11 to each of points on the ground surface 4 by the laser range finder, and outputs the measured value. The 3D coordinate values of the points on the ground surface 4 in a predetermined field of view are calculated based on the measurement values, the position of the walking apparatus 1, and the position and attitude of each of joints. Thus, point group data (point cloud) showing the shape of the ground surface 4 is obtained. The walking apparatus 1 can carry out the walking which is adequate to the state of the ground surface 4 by using this point group data. The walking apparatus 1 further transmits the point group data to the operation section 2. The operation section 2 can display the shape of the ground surface 4 on a display device based on the received point group data. The operator can see a display screen of the display device (an output unit) and transmit an appropriate walking command to the walking apparatus 1.

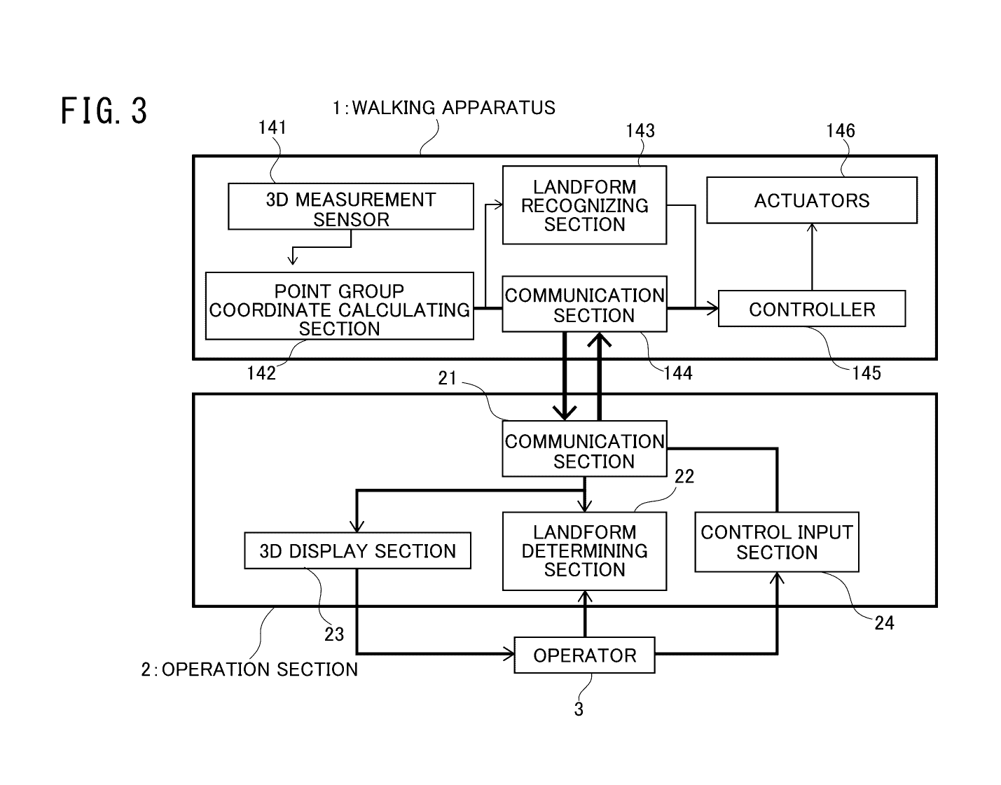

FIG. 3 is a block diagram showing the configuration of the robot system. The walking apparatus 1 has a 3D measurement sensor 141, a point group coordinate calculating section 142, a landform recognizing section 143, a communication section 144, a controller 145 and actuators 146. The 3D measurement sensor 141 is equivalent to the 3D measurement sensor 11 shown in FIG. 2.

The point group coordinate calculating section 142 and the landform recognizing section 143 are functional blocks implemented by reading out and executing a program which has been stored in a non-transitory recording medium, by a processing unit of the walking apparatus 1 (e.g. a computer). By executing the program by a hardware processor built-in the processing unit, the processing unit implements functions of the point group coordinate calculating section 142 and the landform recognizing section 143. In other words, the point group coordinate calculating section 142 and the landform recognizing section 143 are realized by the processing unit. The communication section 144 is a communication interface to carry out a radio communication with the operation section 2.

The actuator 146 is a driving unit that drives an angle of each of joints (limb joints) of the walking apparatus 1. The controller 145 is a computer that controls operations and actions of the walking apparatus 1. The walking apparatus 1 can performs actions such as walking by driving the joints of the walking apparatus 1 by the actuators 146 based on a command value outputted from the controller 145. Note that the walking apparatus 1 has a plurality of actuators 146 for a plurality of joints, respectively. Each of the actuators changes an angle of the corresponding one of the joints or keeps the angle of the corresponding joint.

The operation section 2 has a communication section 21, a landform determining section 22, a three-dimensional (3D) display section 23 (an output unit) and a control input section 24 (an input unit). The communication section 21 is a communication interface to communicate with the walking apparatus 1. The landform determining section 22 is a functional block implemented by reading out and executing a program which has been stored in a non-transitory recording medium by the processing unit of the operation section 2 (e.g. a computer). The processing unit functions as the landform determining section 22 which carries out landform determination processing by executing the program by a hardware processor built-in the processing unit. In other words, the landform determining section 22 is implemented by the processing unit. The 3D display section 23 is a display device which can display a perspective view of the landform undulation and so on. The control input section 24 is an input device such as a keyboard, a pointing device, and a touch-panel, which receives an input operation from the operator 3.

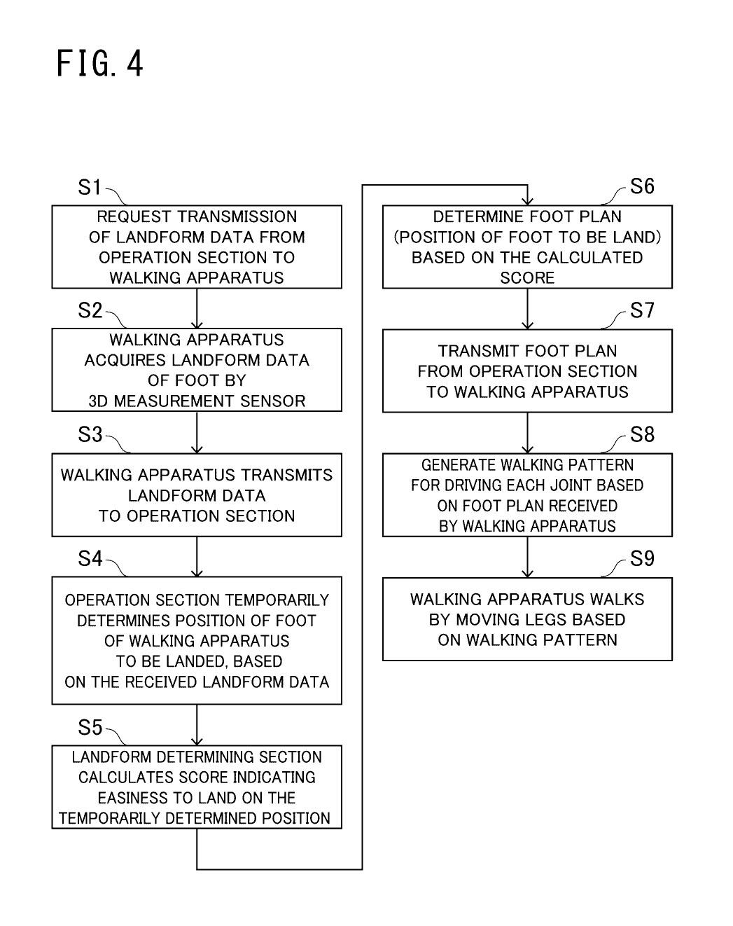

In the present embodiment, an undulation avoidance control is applied to the walking apparatus 1 such that the walking apparatus 1 walks while avoiding the ground surface 4 having a large undulation. FIG. 4 is a flow chart of the undulation avoidance control.

### [Step S1]

In an initial condition, it is supposed that the walking apparatus 1 stops walking and stays at a place. The operator 3 carries out an input operation to the control input section 24 of the operation section 2 to request the transmission of landform data. In response to the input operation, a landform data transmission request (a request signal) is transmitted to the walking apparatus 1 by the radio communication.

### [Step S2]

When receiving the landform data transmission request, the walking apparatus 1 controls or adjusts the angle of a head such that the field of view 111 of the ground surface 4 measured by the 3D measurement sensor 141 is a front area of the foot of the walking apparatus 1. In such a condition, the 3D measurement sensor 141 scans the ground surface 4 in the field of view 111. Thus, data is generated which shows a distance to each of many points on the ground surface 4 in the field of view 111 by the 3D measurement sensor 141 such as the laser range finder.

The point group coordinate calculating section 142 calculates the point group data showing 3D coordinate values of the many points on the ground surface 4 in a coordinate system such as a world coordinate system based on the data generated by the 3D measurement sensor 141 and data of the position and attitude of the walking apparatus 1 which are acquired from detection values of encoders of the actuators 146. The landform recognizing section 143 generates landform data showing the shape of the ground surface 4 based on the coordinate values of the point group data.

### [Step S3]

The walking apparatus 1 transmits the generated landform data (a signal corresponding to the landform data) to the operation section 2.

### [Step S4]

When the operation section 2 receives the landform data, the 3D display section 23 displays on a display screen, the three-dimensional shape of the ground surface 4 which is specified based on the landform data. The operator 3 refers to the display screen to consider where the foot to be stepped forward next of the walking apparatus 1 (the left foot 12 or the right foot 13) should be landed. The operator 3 operates a pointer of a pointing device on the screen through the control input section 24 to temporarily determine a landing position candidacy, i.e. a candidacy of a position where the foot is landed. That is, the control input section 24 (the input unit) functions as a specification position generating section which specifies the landing position candidacy on the ground surface 4. In this case, the control input section 24 functions as the specified position generating section which generates the specification position to the ground surface 4 (the landing position candidacy). At this time, in addition to the input of the landing position candidacy, the attitude of the foot may be specified (an orientation of the foot in a length direction in a horizontal plane, i.e. an orientation of the tiptoe).

### [Step S5]

The landform determining section 22 (the processing unit) executes the landform determination processing. More specifically, the landform determining section 22 (the processing unit) calculates a score indicating easiness to land the foot to a position, stability of the position where the foot is landed, or a landform determination value indicating a flatness of the landform, by using the landform data of the landing position candidacy (permitted to contain the landform data around the landing position candidacy), and displays the calculated score on the 3D display section 23. The foot can be landed more stably as the score becomes smaller, and the foot cannot be landed more stably as the score becomes larger, so that the position should be avoided. A method of calculating the score will be described later.

### [Step S6]

The operator 3 refers to the score displayed on the 3D display section 23 (the output unit) to objectively know the stability of the inputted landing position candidacy. The operator 3 corrects the landing position candidacy and inputs the corrected landing position candidacy to the control input section 24 again, when the score is large to a certain extent. In this case, the landform determining section 22 calculates the score of the corrected landing position candidacy to display on the 3D display section 23. In this way, the operator 3 refers to the score of one landing position candidacy or each of more landing position candidacies, to determine the position (a landing command position, i.e. a movement target position) of the foot (the foot sole) to be commanded to the walking apparatus 1.

### [Step S7]

The operator 3 inputs the landing command position (the movement target position) through the input operation to the control input section 24 (the input unit). The operation section 2 transmits data showing the landing command position (a command value corresponding to the landing command position) to the walking apparatus 1 as a foot plan.

### [Step S8]

When receiving the foot plan, the controller 145 of the walking apparatus 1 generates control command values to the actuators 146 such as a rotation angle of each joint (containing an angle of an ankle joint) such that the stepping foot lands on the landing command position of the ground surface 4.

### [Step S9]

The controller 145 drives the actuators 146 based on the generated control command values. As a result, the foot of the walking apparatus 1 (the right foot or the left foot) lands on the ground surface 4 of the landing command position specified by the operator. Thus, a walking pattern commanded by the operator 3 is realized.

### [Calculating Method of Score]

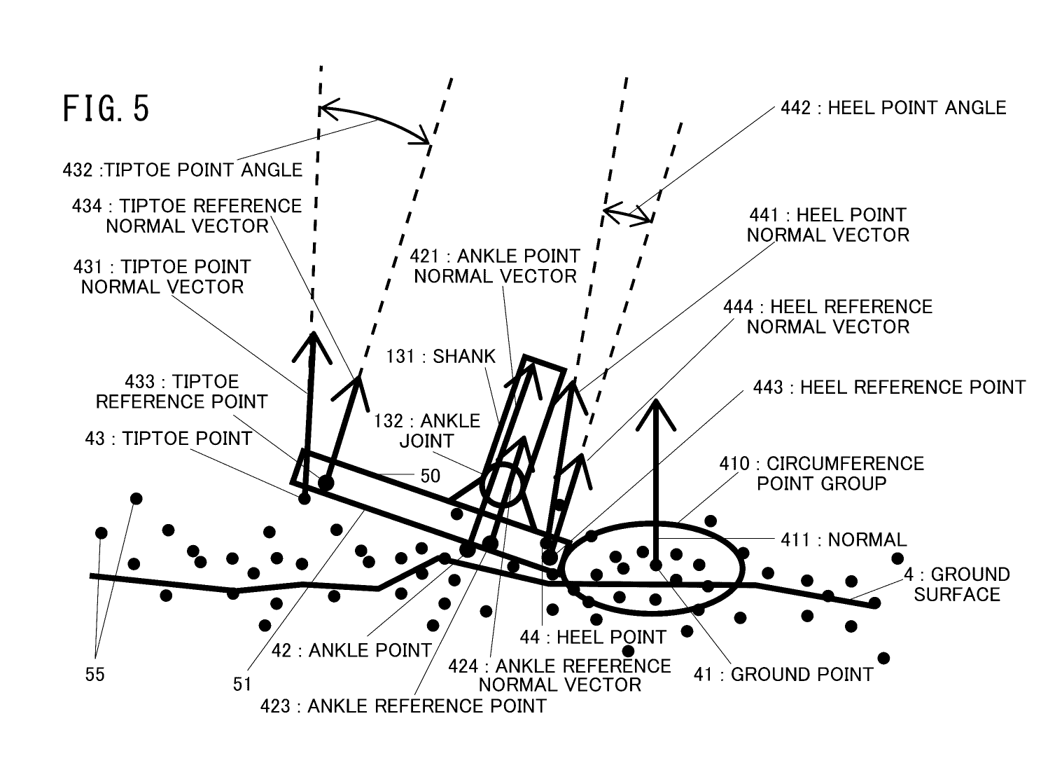

Next, the score as a landform determination value generated by the landform determining section 22 (the processing unit) at the step S5 will be described. FIG. 5 is a side view showing the neighborhood of the ankle of the leg of the walking apparatus 1 and the ground surface 4. In FIG. 5, the foot immediately before landing is shown. Referring to FIG. 5, the score will be described. Note that the processing of calculating the landform determination value corresponds to the landform determination processing.

In this description, a link member to an ankle joint from a knee joint of the leg of the walking apparatus 1 is referred to as a shank section 131. The lower end of the shank 131 is connected to the foot 50 through the ankle joint 132. The foot 50 is connected with the shank 131 through the ankle joint 132 to be tunable. The actuator 146 changes or maintains a turn angle of the ankle joint 132. The ankle joint 132 is an ankle pitch axis joint so as to turn the foot 50 in a length direction of the foot 50 (typically, a back and forth direction of the walking apparatus 1, or a direction coincident with the progress direction). That is, the ankle pitch axis joint is a rotation joint that rotates around a rotation axis orthogonal to both of a longitudinal direction of the foot 50 (for example, the direction from the heel to the toe) and the longitudinal direction of the shank section 131 (for example, the direction from the knee to the ankle). As another example of the ankle joint 132, there is a roll axis joint to make the foot fluctuate in the left and right directions. The roll axis joint is a joint that rotates around the rotation axis parallel to the longitudinal direction of the foot (for example, the direction from the heel to the toe). The ankle joint 132 may have an ankle pitch axis joint and the ankle roll axis joint.

The foot 50 has a sole foot 51 as the lower-side surface. An ankle reference point 423, a tiptoe reference point 433 and a heel reference point 443 are set to the foot sole 51. The ankle reference point 423 is set to a position that is relatively near the ankle joint 132. It is desirable to set a point, which is handled as a point of action of the floor reaction, as the ankle reference point 423 when a ZMP (zero moment point) control is carried out to the walking apparatus 1. A point which is situated beneath the ankle joint 132 in the vertical direction in a state that the walking apparatus 1 stands stably on a level ground surface 4 is set as the ankle reference point.

A virtual sole plane which has a shape along the foot sole 51 is set to the foot sole 51. For example, the virtual sole plane is a plane which has a shape along the foot sole 51. A vector extending in a direction perpendicular to the virtual sole plane from the ankle reference point 423 is shown in FIG. 5 as an ankle reference normal vector 424.

At least one inspection point is set on a point of the foot sole 51 farther away from the ankle reference point 423 not the ankle joint 132. In the following description, the ankle reference point 423 is set near the ankle joint 132 as an important point to support the weight of the walking apparatus 1. Also, the inspection point of the foot sole 51 farther from the ankle reference point 423 is set. Processing of inspecting the landform undulation at the inspection point is carried out. The ankle reference point 423 and the inspection point are points on the virtual sole plane, respectively.

As a specific instance of the inspection point, a first inspection point is set to the foot sole 51 on the front side to the ankle reference point 423. In an example of FIG. 5, as a first inspection point, a tiptoe reference point 433 is set near the tiptoe 133 of the foot 50. On the other hand, a second inspection point is set to the foot sole 51 on the rear side to the ankle reference point 423. In an example of FIG. 5, as a second inspection point, a heel reference point 443 is set near the heel 134 of the foot 50.

In the side view of FIG. 5, the depth direction of the foot 50 is not shown because it is orthogonal to the paper sheet. However, two points may be provided at the left and right ends near the tiptoe as the first inspection points, and two points may be provided at the left and right ends near the heel as the second inspection points. That is, it is desirable that the inspection points are provided at four corners. When being set in this way, both of an inclination of the ground surface 4 in the front-back direction (the pitch axial direction) to the foot sole 51 and an inclination in the left-right direction (the roll axial direction) can be reflected to the score. The positions of the ankle reference point 423 and the inspection points can be optionally set through an input operation to the control input section 24 of the operation section 2.

Next, data on the ground surface 4 will be described. At step S2 of FIG. 4, the ground surface 4 is measured by the 3D measurement sensor 141, and the point group data (the point cloud) of the ground surface 4 is generated by the point group coordinate calculating section 142. Many points that are distributed near the ground surface 4 of FIG. 5 show elements of the point group data 55. The points of the point group data 55 are distributed three-dimensionally. In FIG. 5, a plurality of points of the point group data 55 seems to be distributed on a plane. However, actually, the positions of the points of the point group data 55 in the foot width direction (the depth direction in the paper) are different from each other. On the other hand, in FIG. 5, the reference numeral 4 denotes the ground surface in a sectional plane orthogonal to a horizontal plane.

Data of the undulation of the ground surface 4 can be obtained from the point group data 55. Using a point 41 shown in FIG. 5 as an example, undulation data extraction processing will be described. An optional point of the point group data 55 can be set as a point 41. The points of the point group data 55 distributed around the point 41 are set as a circumference point group 410. The circumference point group 410 is the point group data 55 that are three-dimensionally distributed in a predetermined distance around the point 41 as a center.

A regression plane is found by applying the least square method and so on to the point group data 55 of the circumference point group 410. This regression plane approximately shows the inclination of the ground surface 4 at the point 41. A point normal vector 411 is determined as a normal vector to the regression plane. The landform determining section 22 has a function to calculate the point normal vector 411 showing the undulation data at an optional point 41 based on the point group data 55.

The following processing is carried out based on the undulation data calculated as mentioned above:

(1) the landform following control to put the foot to be parallel to the ground surface 4 when the walking apparatus 1 walks; and

(2) the processing of calculating a score showing the stability of the point on which the foot is put.

Hereinafter, these operations will be described in order.

### [Landform Following Control]

First, the landform following control will be described. The controller 145 carries out the landform following control such that the foot sole 51 of the walking apparatus 1 lands in substantially parallel to the ground surface 4. First, a landform recognizing section 143 carries out foot landform detection processing as follows. One point of the point group data 55 that is the nearest to the ankle reference point 423 is set as an ankle point 42. The point normal vector 411 at the ankle point 42 is calculated as an ankle point normal vector 421 through undulation data extraction processing.

The controller 145 controls the actuators 146 (for example, the pitch axis joint and the roll axis joint of the ankle) such that an ankle reference normal vector 424 showing an angle of the foot becomes parallel to the ankle point normal vector 421 showing an angle of the ground surface 4, when the foot lands. In other words, the controller 145 controls the angle of the ankle joint such that a part of the foot sole 51 corresponding to the ankle reference point 423 becomes parallel to the ground surface 4 at the specification position (the movement target position of the foot sole). By such a control, the foot can be put in parallel to the ground surface 4 at a position directly beneath the ankle that is important to support the weight of the walking apparatus 1, even when the ground surface 4 has an inclination. As a result, the walking is stabilized.

### [Score Calculation Processing]

Next, the score calculation processing (i.e. the landform determination processing) will be described. The operation section 2 has a function to carry out relative angle calculation processing of calculating the relative angle between a predetermined position of the foot sole 51 and the ground surface 4 based on the undulation data. Next, the relative angle calculation processing will be described. The operation section 2 can know the coordinate value of the tiptoe reference point 43 in the world coordinate system 3 based on the position data of the preset inspection point, and data showing the current position and attitude of the walking apparatus 1 received from the walking apparatus 1. Therefore, it is possible to position the tiptoe reference point 433 to the point group data 55 (the landform point cloud). That is, it is possible to relate the coordinate value of the tiptoe reference point 433 and the coordinate value of each group data 55.

It is supposed that a virtual sole plane as a plane containing the ankle reference point 423 and the inspection points is virtually arranged such that the ankle 423 overlaps with the above-mentioned specification position and the virtual sole plane becomes parallel to the ground surface 4 at the specification position (a part of the ground surface corresponding to the specification position). In other words, it is supposed that a virtual sole plane as a plane containing the ankle reference point 423 and the inspection points is virtually arranged such that the ankle reference normal vector 424 becomes parallel to the ankle point normal vector 421 showing the angle of the ground surface 4. In this case, the landform determining section 22 (the processing unit) calculates the coordinate value of the tiptoe reference point 433 (the inspection point), the coordinate value of the heel reference point 443 (the inspection point), the coordinate value of the ankle reference point 423 (the reference point) and so on. Note that the coordinate value of the ankle reference point 423 (the reference point) and so on may be calculated in the calculation processing of the above-mentioned landform following control.

One of the points of the point group data 55 that is the nearest to the tiptoe reference point 433 is extracted as the tiptoe point 43 based on the coordinate value of the tiptoe reference point 433. The calculation of the point normal vector 411 is carried out in the tiptoe point 43, and a calculation result is obtained as a tiptoe point normal vector 431. The tiptoe point normal vector 431 shows the inclination of the ground surface 4 near the tiptoe.

Moreover, the landform determining section 22 calculates a tiptoe reference normal vector 434 that directs to a direction perpendicular to the foot sole 51 in the tiptoe reference point 433. The landform determining section 22 further calculates a tiptoe point angle 432 as an angle between the tiptoe reference normal vector 434 and the tiptoe point normal vector 431 (in other words, a relative angle between the virtual sole plane and the ground surface 4 in the tiptoe reference point 433 (the inspection point)). The calculation processing of the relative angle is relative angle calculation processing. The relative angle calculation processing is processing which is carried out by the landform determining section 22 (the processing unit). In the relative angle calculation processing, it is supposed that the virtual sole plane as a plane which contains the ankle reference point 423 and an inspection point is virtually arranged such that the ankle reference point 423 overlaps with the above-mentioned specification position and the virtual sole plane becomes parallel to the ground surface 4 at the specification position (a part of the ground surface corresponding to the specification position). In this case, the relative angle between the virtual sole plane and the ground surface 4 at the tiptoe reference point 433 (the inspection point) is calculated based on the landform data and so on (for example, the landform data, data showing the position and direction of the virtual sole plane, data showing a position of each reference point, data showing the position of the inspection point and so on).

The landform determining section 22 carries out relative angle calculation processing on the heel in the same way. First, one of the points of the point group data 55 that is the nearest to a heel reference point 443 set for the foot sole 51 on the rear side from the ankle reference point 423 is set as a heel point 44. A heel point normal vector 441 is calculated by carrying out undulation data extraction processing at the heel point 44. Moreover, a heel reference normal vector 444 perpendicular to the foot sole 51 is calculated at the heel reference point 443. The landform determining section 22 further calculates a heel point angle 442 as an angle between the heel reference normal vector 444 and the heel point normal vector 441 (in other words, a relative angle between the virtual sole plane and the ground surface 4 at the heel reference point 443 (the inspection point)).

Here, when the virtual sole plane set to the foot sole 51 is flat, the tiptoe reference normal vector 434 and the heel reference normal vector 444 are parallel to the ankle reference normal vector 424. Therefore, it is not necessary to calculate the tiptoe reference normal vector 434 and the heel reference normal vector 444 for the calculation of the tiptoe point angle 432 and the heel point angle 442, and instead, it is sufficient to use the ankle reference normal vector 424.

The landform determining section 22 carries out landform determination value calculation processing. In the landform determination value calculation processing, the landform determining section 22 (the processing unit) calculates the landform determination value that is a score of the undulation of the ground surface 4 based on the tiptoe point angle 432 and the heel point angle 442. The landform determination value is a value indicating the flatness of the landform (or, the degree of undulation). For example, a value obtained by adding the tiptoe point angle 432 and the heel point angle 442 is calculated as the score. When the two tiptoe reference points 433 and the two heel reference points 443 are set, a summation of angles at these four points is calculated as the score.

This score has the following meaning. That is, the walking apparatus 1 lands in substantially parallel to the ground surface 4 at the ankle reference point 423 by the landform following control. At this time, when the tiptoe point angle 432 and the heel point angle 442 are great, the foot sole 51 cannot be landed in parallel to the ground surface 4 at the tiptoe and the heel, so that the stability is low. Therefore, by referring to the score which is calculated based on these angles, the stability of the ground surface 4 where the foot is planned to be put can be known.

In the above description, the tiptoe reference point 433 and the heel reference point 443 are used for the calculation of the score, but another example is also thought of as the method of calculating score. The calculation of the score can be carried out if at least one inspection point is set. Also, the score can be calculated by setting many inspection points. A normal vector of the ground surface 4 to each of all the points of the point group data 55 in the positions which overlap with the foot sole 51 in the horizontal plane when viewed from the vertical direction is calculated and these normal vectors may be used for the calculation of the score. In such a case, an average of the angles of the normal vectors of the ground surface 4 to the normal vectors of the foot sole 51 in the points of the point group data 55 may be used as the score.

In the above-mentioned example, the greater score shows the lower flatness of the ground surface 4. However, oppositely, the greater score may show the higher flatness of the ground surface 4. For example, such a method can be realized by adding a reciprocal of the relative angle at each of the points to calculate the score. In case of such a score, the operator 3 generates a foot plan by selecting points with higher scores as a position with high stability.

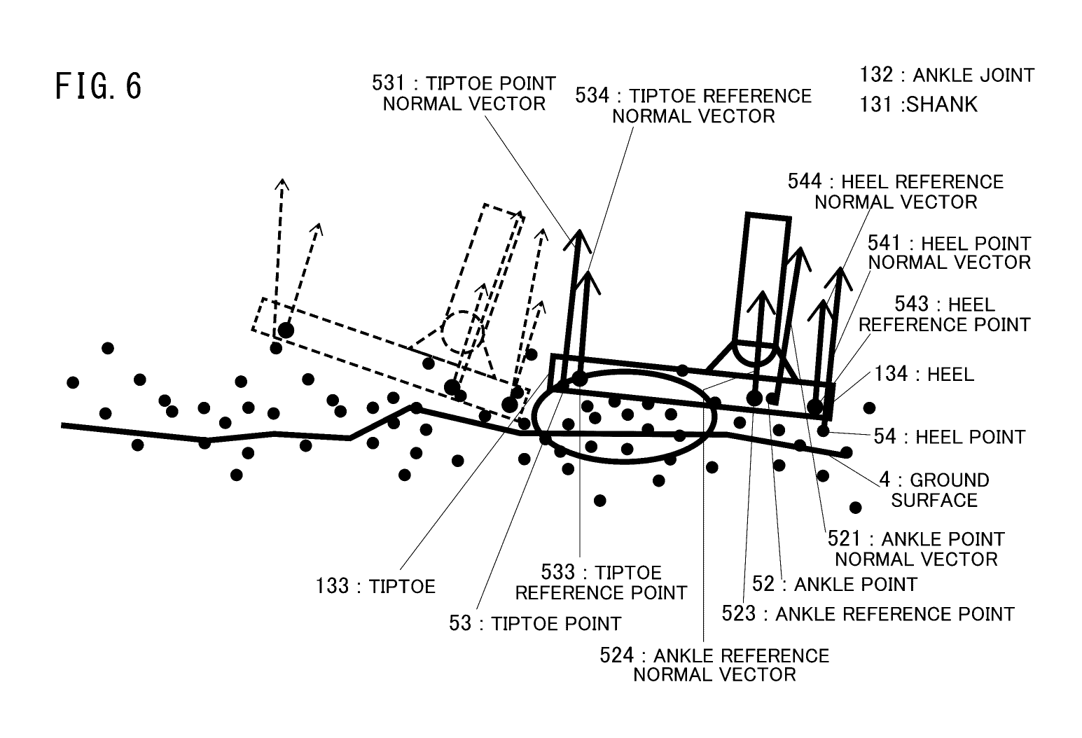

The operator 3 refers to the scores to determine a position where is suitable to put the foot of the walking apparatus 1, as described at the step S6 of FIG. 4. For example, it is supposed that the operator 3 first inputs a position shown by the broken line in FIG. 6 as one landing position candidacy. The landform determining section 22 calculates and displays the score in the position. For example, when the operator 3 determines that the score is great, the operator 3 corrects the landing position candidacy to be shifted to a position behind a little bit, as shown by the solid line on the right side of FIG. 6. The landform determining section 22 calculates and displays the score in the corrected landing position candidacy. The operator inputs the position as a landing command position when the operator determines that the score in the corrected position is small sufficiently.

Such a control is effective when the situation of the ground surface 4 is unknown and it is required to make the walking apparatus 1 walk carefully. Although the present embodiment can be applied to the leg type mobile robot irrespective of the number of legs, especially, the effectivity is high in the control of the bipedal walking robot in which the high stability to each foot is required.

In the above-mentioned description, a case where the next step of the walking apparatus 1 is set has been described as an example. However, the operator 3 can set the foot plan that contains a series of planned landing positions of the feet to walk in a predetermined area by using the operation section 2. Such a usage will be described below.

The walking apparatus 1 carries out autonomous walk on the ground surface 4. In this case, the controller 145 functions as the specification position generating section which generates the specification positions specified to the ground surface 4 based on the foot plan which has been stored previously or is generated according to the environment. At this time, a previously mentioned landform following control is carried out. That is, the controller 145 controls the foot sole 51 to become parallel to the ground surface 4 in the ankle reference point 423 when the foot sole 51 is put on the specification position of the ground surface 4.

The walking apparatus 1 transmits the landform data measured with the 3D measurement sensor 141 to the operation section 2 while walking to put the foot on the specification position. The operator 3 refers to the landform data displayed on the 3D display section 23 to instruct to stop the walking of the walking apparatus 1 when the walking apparatus 1 enters a location where there is much undulation of the ground surface 4. The walking apparatus 1 is set to a command waiting state.

The operator 3 selects a position with a small score through the operation shown in the steps S4 to S6 and inputs the position as a landing command position for a first step in the foot plan. The operation section 2 stores the position as foot plan data. Next, the operator 3 inputs the landing command position for a second step by the operation shown in the steps S4 to S6 to a position where the walking apparatus 1 can reach from the position of the first step. Hereinafter, in the same way, the foot plan of the first step to the n^{th} step is inputted. When the operator 3 carries out a predetermined input operation to the control input section 24, the foot plan data is transmitted to the walking apparatus 1. The walking apparatus 1 can walk on a route with little landform undulation by walking according to the foot plan.

The present invention is not limited to each of the above embodiments. It would be apparent that the embodiments may be appropriately modified or changed in the range of features of the present invention. Also, unless causing any technical contradiction, various techniques used in the embodiments or the modifications can be applied to the other embodiments or the modifications.

The present patent application is based on Japanese Patent Application JP 2014-50816 filed on Mar. 13, 2014 and claims a priority based on the application. The disclosure thereof is incorporated herein by reference.

1. A robot system comprising:
a sensor configured to generate landform data showing a shape of a ground surface;
a storage device which stores a program; and
a processing unit which executes the program to implement:
a specification position generating section which specifies a specification position on the ground surface;
a landform determination processing section which carries out relative angle calculation processing of calculating a relative angle between a virtual surface and the ground surface in at least one inspection point based on the landform data, when the virtual plane in which a reference point and the at least one inspection point are set is arranged such that the reference point overlaps with the specification position and such that the virtual surface becomes parallel to the ground surface in the specification position; and landform determination value calculation processing of calculating a landform determination value indicating a flatness of the landform based on the relative angle; and
a control section which controls walking of a robot based on the landform determination value.

2. The robot system according to claim 1, wherein the virtual surface is set based on a shape of a foot sole of a foot of a leg type mobile robot as the robot, and
wherein the at least one inspection point is set to a position which is farther away from an ankle joint of the foot of the leg type mobile robot than the reference point.

3. The robot system according to claim 2, wherein the at least one inspection point comprises a first inspection point set on a tiptoe side of the foot from the reference point, and a second inspection point set on a heel side of the foot from the reference point, and
wherein the landform determination value is calculated based on the relative angle in the first inspection point and the relative angle in the second inspection point.

4. A leg type mobile robot system comprising:
a sensor configured to generate landform data showing a shape of a ground surface;
a storage device which stores a program; and
a processing unit which executes the program to implement:
a specification position generating section which specifies a specification position on the ground surface, and
a landform determination processing section which carries out relative angle calculation processing of calculating a relative angle between a virtual surface and the ground surface in at least one inspection point based on the landform data, when the virtual plane in which a reference point and the at least one inspection point are set is arranged such that the reference point overlaps with the specification position and such that the virtual surface becomes parallel to the ground surface in the specification position; and landform determination value calculation processing of calculating a landform determination value indicating a flatness of the landform based on the relative angle;
a leg type mobile robot having a leg connected to a foot through an ankle joint; and
a controller configured to control an angle of the ankle joint based on the landform determination value such that a part of a foot sole of the foot corresponding to the reference point becomes parallel to the ground surface in the specification position, when the foot sole should be put on the specification position, and control walking of the leg type mobile robot based on the landform determination value,
wherein the virtual surface is set based on a shape of the foot sole of the foot of a robot, and
wherein the at least one inspection point is set to a position which is farther away from the ankle joint of the foot of the robot than the reference point.

5. A robot system comprising:
a leg type mobile robot; and
a remote control terminal,
wherein the leg type mobile robot comprises:
a leg connected to a foot through an ankle joint;
a sensor configured to generate landform data showing a shape of a ground surface; and
a controller configured to control an angle of the ankle joint based on the landform determination value such that a part of a foot sole of the foot corresponding to a reference point becomes parallel to a ground surface in a specification position, when the foot sole should be put on the specification position,
wherein the remote control terminal comprises:
an input device;
a storage device which stores a program;
a processing unit which executes the program to implement:
a specification position generating section which specifies the specification position on the ground surface based on an input operation to the input device; and
a landform determination processing section which carries out relative angle calculation processing of calculating a relative angle between a virtual surface and the ground surface in at least one inspection point based on the landform data, when the virtual plane set with a reference point and the at least one inspection point is arranged such that the reference point overlaps with the specification position and such that the virtual surface becomes parallel to the ground surface in the specification position; and landform determination value calculation processing of calculating a landform determination value indicating a flatness of the landform based on the relative angle; and
an output device which outputs the landform determination value,
wherein the virtual surface is set based on a shape of the foot sole of the foot, and
wherein the at least one inspection point is set to a position which is farther away from the ankle joint of the foot than the reference point,
wherein the remote control terminal transmits a command value corresponding to a movement target position to the leg type mobile robot, when the input operation is carried out to set the specification position as the movement target position of the foot sole, and
wherein the leg type mobile robot controls the angle of the ankle joint based on the command value.

6. A control method of a robot, comprising:
acquiring landform data showing a shape of a ground surface by a robot;
specifying a specification position on the ground surface by a remote control terminal;
calculating, by the remote control terminal, a relative angle between a virtual plane and the ground surface in at least one inspection point based on the landform data when the virtual plane on which a reference point and the at least one inspection point are set is arranged such that the reference point overlaps with the specification position and such that the virtual plane becomes parallel to the ground surface in the specification position;
calculating, by the remote control terminal, a landform determination value indicating a flatness of the landform based on the relative angle; and
controlling walking of the robot based on the landform determination value.

7. The control method according to claim 6, wherein the virtual plane is set based on the shape of the foot sole of a foot of a leg type mobile robot, and
wherein the at least one inspection point is set in a position which is farther away from the ankle joint of the foot of the leg type mobile robot than the reference point.

8. The landform determining method according to claim 7, wherein the at least one inspection point includes a first inspection point set on a tiptoe side from the reference point, and a second inspection point set on a heel side of the foot from the reference point, and
wherein the landform determination value is calculated based on the relative angle in the first inspection point and the relative angle in the second inspection point.

9. A control method of a leg type mobile robot, comprising:
acquiring landform data showing a shape of a ground surface by a robot;
specifying a specification position on the ground surface by a remote control terminal;
calculating, by the remote control terminal, a relative angle between a virtual plane and the ground surface in at least one inspection point based on the landform data when the virtual plane on which a reference point and the at least one inspection point are set is arranged such that the reference point overlaps with the specification position and such that the virtual plane becomes parallel to the ground surface in the specification position;
calculating, by the remote control terminal, a landform determination value indicating a flatness of the landform based on the relative angle;
wherein the virtual plane is set based on the shape of the foot sole of a foot of the leg type mobile robot;
wherein the at least one inspection point is set in a position which is farther away from the ankle joint of the foot of the leg type mobile robot than the reference point; and
controlling an angle of the ankle joint based on the landform determination value such that a part of the foot sole corresponding to the reference point becomes parallel to the ground surface in the specification position, when the foot sole of the leg type mobile robot should be put on the specification position.

10. A method of controlling a robot system comprising a leg type mobile robot and a remote control terminal,
the method comprising:
acquiring landform data showing a shape of a ground surface by the leg type mobile robot;
specifying a specification position on the ground surface based on an input operation to an input device of the remote control terminal;
calculating, by a processing unit of the remote control terminal, a relative angle between a virtual plane and the ground surface based on the landform data when the virtual plane set with a reference point and the at least one inspection point is virtually arranged such that the reference point overlaps with the specification position, and such that the virtual plane becomes parallel to the ground surface in the specification position;
calculating, by the processing unit, a landform determination value indicating a flatness of the landform;
transmitting, by the remote control terminal, a command value corresponding to a movement target position to the leg type mobile robot, when the specification position is determined as the movement target position of a foot sole of the leg type mobile robot; and
controlling, by the leg type mobile robot, an angle of an ankle joint of a leg of the leg type mobile robot based on the command value corresponding to the landform determination value,
wherein the virtual plane is set based on a shape of the foot sole of the leg type mobile robot,
wherein the at least one inspection point is set to a position which is farther away from the ankle joint of the leg than the reference point, and
wherein the specifying the specification position comprises specifying the specification position through an input unit of the remote control terminal.

11. (canceled)
